(19) United States
(12) Patent Application Publication
(10) Pub. No.: US 2013/0304963 A1
(43) Pub. Date: Nov. 14, 2013

(54) MEMORY MANAGING DEVICE AND METHOD AND ELECTRONIC APPARATUS

(71) Applicant: SONY CORPORATION, Tokyo (JP)

(72) Inventors: Yu LUO, Pudong New Area Shanghai (CN); Yingtao HU, Pudong New Area Shanghai (CN)

(73) Assignee: Sony Corporation, Tokyo (JP)

(21) Appl. No.: 13/870,381

(22) Filed: Apr. 25, 2013

(30) Foreign Application Priority Data
May 10, 2012 (CN) 201210144472.5

(51) Int. Cl. G06F 3/06

(52) U.S. Cl. CPC G06F 3/0679
USPC 711/102

(57) ABSTRACT

A memory managing device and method and an electronic apparatus are provided. The memory managing device is applied to a memory having a plurality of storage regions capable of being separated physically, comprising: a storage detecting unit for detecting the current storage status of the memory; a block computing unit for computing the current active block in the memory; a discreteness deciding unit for deciding whether the discreteness of a segment in the memory is larger than a predetermined threshold; a segment arranging unit for arranging the segment when the discreteness is larger than the predetermined threshold to move the active block to a set of storage regions whose number of the storage regions is less than that before the movement; and a power consumption setting unit for setting the storage regions other than the set of the storage regions in the memory to a low power consumption status. With the memory managing device and method and electronic apparatus according to the embodiment of this application, all of the active blocks in the memory can be concentrated into less physical storage regions so that the power consumption of the memory can be reduced while the efficiency of the usage of the memory can be increased.

### BACKGROUND

The present invention relates to data storage field, and in particular, relates to a memory managing device and method and an electronic apparatus.

NVRAM (Non-Volatile Random Access Memory) refers to RAM (Random Access Memory) that is capable of holding data after power-off, i.e., RAM that the stored data is not lost after power-off. RAM that is opposite thereto includes SRAM and DRAM (it is also divided into SDRAM, DDR SDRAM, DDR2 SDRAM, RDRAM, Direct RDRAM, etc.) whose information is lost after power-off.

And, NVRAM can be accessed randomly as RAM, i.e., when the data in such memory is read or written in, the time required is not related to the position at which this piece of information is. Contrarily, when the information in sequential access storage is read or written in, the time required is related to the position (for example, a Magnetic Tape). Therefore, such RAM has almost the fastest speed of reading and writing-in among all of the access apparatuses, the access delay thereof appears negligible compared to other storage related to mechanical operation.

In current computer system, memory is a typical example of the random access memory, this is because the memory is a storage component mounted directly on the main-board and communicating directly with the CPU and for storing data, it needs a certain access speed.

Based on the characteristic of NVRAM, the storage speed thereof can reach about 100 MHz, which is approximate to the conventional memory, for example the storage speed of SDRAM (about 133 MHz), and, NVRAM can still hold the data stored in case of power-off. Therefore, due to the characteristics of non-off in case of power-off, and random access, NVRAM has a stronger expansibility than the conventional memory, and its customizable degree is higher.

Based on the characteristic of NVRAM, the NVRAM can replace the memory as the internal storage of the computer system, and the NVRAM can be used as the internal storage of other electronic apparatus such as smart phone, further, the NVRAM may also be used to connect with computer and other electronic apparatus as external storage, for example hot-plug.

Due to the physical structure, the conventional storage system based on disk track addressing such as the hard disk of the computer system becomes the bottleneck of delaying data read-write speed increasingly, and with the popularization of the NVRAM, it exhibits a trend of replacing the hard disk as mass memory and external portable memory.

Therefore, with the gradually wide use of NVRAM, there generates the need of a memory managing scheme fitting such new storage medium.

### SUMMARY

Therefore, the invention is made in view of the problem and need existing in the related art mentioned above.

The object of the embodiments of the present invention is providing a memory managing device and method and an electronic apparatus which are capable of reducing the number of the storage region in active status in the memory so as to reduce power consumption.

According to one aspect of the embodiment of the present invention, there provides a memory managing device applied to a memory having a plurality of storage regions capable of being separated physically, comprising: a storage detecting unit configured to detect the current storage status of the memory; a block computing unit configured to compute the current active block in the memory based on the current storage status of the memory; a discreteness deciding unit configured to decide whether the discreteness of a segment in the memory is larger than a predetermined threshold based on a storage address of the current active block; a segment arranging unit configured to arrange the segment when the discreteness is larger than the predetermined threshold to move the active block to a second set of storage regions, wherein, the active block is in a first set of storage regions before being moved, and the number of the storage region in the first set of storage regions is larger than the number of the storage region in the second set of storage regions; and a power consumption setting unit configured to set the storage regions other than the second set of storage regions in the memory to a low power consumption status.

In the memory managing device, the memory is a NVRAM memory.

In the memory managing device, the low power consumption status is a sleep mode or a power-off mode.

In the memory managing device, the segment arranging unit is configured to arrange the segments in units of a single data file.

In the memory managing device, the segment arranging unit further comprises: a data associating module configured to associate a specific plurality of data files, wherein, the segment arranging unit is configured to move the plurality of data files associated by the data associating module to the same storage region or adjacent storage regions in the memory.

In the memory managing device, the data associating module is configured to associate the plurality of data files based on the attribute of the data files or the preference of user.

In the memory managing device, the data associating unit is configured to create a history record table of the active data file for recording the active data file every time when the storage detecting unit detects the storage status of the memory, and, the data associating module is configured to associate a plurality of data files being active simultaneously in a plurality of detections performed at several times.

According to another aspect of the embodiment of the present invention, there provides a memory managing method applied to a memory having a plurality of storage regions capable of being separated physically, comprising: detecting the current storage status of the memory; computing the current active block in the memory based on the current storage status of the memory; deciding whether the discreteness of a segment in the memory is larger than a predetermined threshold based on a storage address of the current active block; arranging the segment when the discreteness is larger than the predetermined threshold to move the active block to a second set of storage regions in the memory, wherein, the active block is in a first set of storage regions before being moved, and the number of the storage region in the first set of storage regions is larger than the number of the storage region in the second set of storage regions; and setting the storage regions other than the second set of the storage regions in the memory to a low power consumption status

In the memory managing method, the memory is a NVRAM memory.

In the memory managing method, the low power consumption status is a sleep mode or a power-off mode.

In the memory managing method, arranging the segment is specifically arranging the segments in units of a single data file.

In the memory managing method, arranging the segment further comprises: associating a specific plurality of data files; and moving the plurality of data files into the same storage region or the adjacent storage region in the memory.

In the memory managing method, associating a specific plurality of data files specifically comprises: associating the plurality of data files based on the attribute of the data files or the preference of user.

In the memory managing method, associating a specific plurality of data files specifically comprises: creating a history record table of the active data file for recording the active data file each time when the storage status of the memory is detected, and associating a plurality of data files being active simultaneously in a plurality of detections performed at several times.

According to another aspect of the embodiment of the present invention, there provides an electronic apparatus comprising a memory having a plurality of storage regions capable of being separated physically, further comprising: a storage detecting unit for detecting the current storage status of the memory; a block computing unit for computing the current active block in the memory based on the current storage status of the memory; a discreteness deciding unit for deciding whether the discreteness of a segment in the memory is larger than a predetermined threshold based on a storage address of the current active block; a segment arranging unit for arranging the segment when the discreteness is larger than the predetermined threshold to move the active block to a second set of storage regions, wherein, the active block is in a first set of storage regions before being moved, and the number of the storage region in the first set of storage regions is larger than the number of the storage region in the second set of storage regions; and a power consumption setting unit for setting the storage regions other than the second set of the storage regions in the memory to a low power consumption status.

With the memory managing device and method and electronic apparatus according to the embodiment of this application, all of the active blocks in the memory can be concentrated to less physical storage regions so that the power consumption of the memory can be reduced while the efficiency of the usage of the memory can be increased.

### BRIEF DESCRIPTION OF THE DRAWINGS

To explain the technical solution in the embodiment of the invention or in the related art more clearly, the figures necessary in the description of the embodiment or the related art are explained simply as follows. It is obvious for those skilled in the art that the figures in the following description are only some embodiments of the invention, and other figures can be obtained from these figures without inventive labor.

FIG. 1 is a schematic block diagram illustrating the memory managing device according to the embodiment of the present invention;

FIG. 2 is a schematic diagram illustrating the storage instance of the memory before the memory managing device according to the embodiment of the present invention carrying out a segment arrangement;

FIG. 3 is a schematic diagram illustrating the storage instance of the memory after the memory managing device according to the embodiment of the present invention carrying out a segment arrangement;

FIG. 4 is a schematic flow chart illustrating the memory managing method according to the embodiment of the present invention.

### DETAILED DESCRIPTION

Hereinafter, the memory managing device and method and electronic apparatus according to the embodiment of the present invention will be described in detail in combination with the accompanying drawings.

The data managing program in the current conventional computer system are all based on the conventional disk, and since the magnetic sheet of the conventional disk keeps high-speed running all the time, the power consumption when the conventional disk is running is difficult to be reduced.

Further, though the flash of NAND type is getting increasingly popular, the power consumption of the data management of the NAND flash is rather larger due to the inherent structure of the NAND flash, therefore, there is no mature data managing scheme for NAND flash.

Based on the contents described above, according to one aspect of the embodiment of the present invention, there provides a memory managing device applied to a memory having a plurality of storage regions capable of being separated physically, comprising: a storage detecting unit configured to detect the current storage status of the memory; a block computing unit configured to compute the current active block in the memory based on the current storage status of the memory; a discreteness deciding unit configured to decide whether the discreteness of a segment in the memory is larger than a predetermined threshold based on a storage address of the current active block; a segment arranging unit configured to arrange the segment when the discreteness is larger than the predetermined threshold to move the active block to a second set of storage regions, wherein, the active block is in a first set of storage regions before being moved, and the number of the storage region in the first set of storage regions is larger than the number of the storage region in the second set of storage regions; and a power consumption setting unit configured to set the storage regions other than the second set of storage regions in the memory to a low power consumption status.

With the memory managing device according to the embodiment of the present invention, whether the memory needs a segment arrangement is decided by detecting the current storage status of the memory, and the idle storage regions in the memory are set to low power consumption status after the segment arrangement is carried out, so as to reduce the whole power consumption of the memory while increasing the usage rate of the memory.

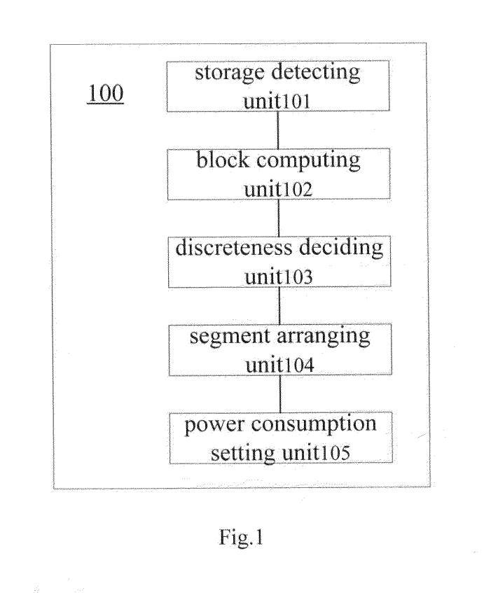

FIG. 1 is a schematic block diagram illustrating the memory managing device according to the embodiment of the present invention. As shown in FIG. 1, the memory managing device 100 according the embodiment of the present invention is applied to a memory having a plurality of storage regions capable of being separated physically, the memory managing device 100 comprises: a storage detecting unit 101 configured to detect the current storage status of the memory; a block computing unit 102 configured to compute the current active block in the memory based on the current storage status of the memory detected by the storage detecting unit 101; a discreteness deciding unit 103 configured to decide whether the discreteness of a segment in the memory is larger than a predetermined threshold based on a storage address of the current active block computed by the block computing unit 102; a segment arranging unit 104 configured to arrange the segment when the discreteness is larger than the predetermined threshold as decided by the discreteness deciding unit 103, to move the active block to a second set of storage regions, wherein, the active block is in a first set of storage regions before being moved, and the number of the storage region in the first set of storage regions is larger than the number of the storage region in the second set of storage regions; and a power consumption setting unit 105 configured to set the storage regions other than the second set of storage regions in the memory to a low power consumption status.

Here, the memory managing device according to the embodiment of the present invention is applied to the memory with a plurality of storage regions that are physically separated to be distinguished from hard disk in the conventional computer system. In the hard disk of the conventional computer system, though it can be partitioned according to the user's need, this partition is only a logical partition, but it can't implement a physical separation. In contrast, in the memory managing device according to the embodiment of the present invention, the applied memory has a plurality of storage regions that are physically separated, thus, each storage region can be set a power consumption mode thereof separately, so as to reach the object of reducing the whole power consumption of the memory.

As mentioned before, preferably, in the memory managing device according to the embodiment of the present invention, the memory is a NVRAM memory. However, those skilled in the art can understand, the memory to which the memory managing device according to the embodiment of the present invention is applied is not limited to the NVRAM memory, the memory managing device according to the embodiment of the present invention can be applied to other types of memory, as long as the memory has a plurality of storage regions that are physically separated. And, those skilled in the art can understand, such memory is not limited to being applied to the computer system as the inner memory or the hard disk of the computer, it can be used as an internal storage device of other electronic apparatus such as smart phone and household appliances, or used as external portable storage device such as mobile hard disk or USB disk.

In the memory managing device according to the embodiment of the present invention, the current storage status of the memory can be detected at a predetermined timing, and the current active blocks can be computed according to a LRU (Least Recently Used), and whether the discreteness of the segment is larger than a predetermined threshold is decided based on the storage address of the active blocks. Here, the frequency of the segment arrangement can be controlled by setting the predetermined threshold, this is because that the segment arrangement will read and write the memory frequently, it consumes much time on one hand, and causes a certain power consumption on the other hand, thus, it needs to be controlled reasonably. In the memory managing device according to the embodiment of the present invention, the predetermined threshold mentioned above is generally set to about 10% to 15%, that is, when the discrete file percentage are over 15% or more of the total files in this segment, it preferably carries out the segment arrangement. Further, as to the procedure of deciding the segment, the storage address of the necessary resource for the program is parsed, and if the storage address of the resource is discontinuous, it decides that there exists segment therein. Further, in case that it decides that the segment arrangement is needed, i.e., when the discreteness of the segment being larger than the set predetermined threshold is decided, the segment arrangement is carried out. At this time, the segment arranging unit will search the continuous idle regions in the storage region, and, if the idle regions is insufficient, it will prompt the user to carry out a deep arrangement to move the active block to the second set of storage regions in the memory, wherein, the active blocks are in the first set of storage regions in the memory before the settlement, and the object of the segment arrangement is to place the active blocks more centralized to make the number of the storage regions in the second set of storage regions less than the number of the storage regions in the first set of storage regions. In this procedure, if the idle regions in some storage regions in the first set of storage regions are sufficient to accommodate the active blocks in other storage regions, the segment arranging unit can concentrate the related data in the respective storage regions in the first set of storage regions into a certain storage regions in the first set of storage regions, further, if the idle regions in the respective storage regions in the first set of storage regions are insufficient, the segment arranging unit can transfer the related data to a storage region newly established, in a word, the data needs to be concentrated to smaller storage regions. Thus, based on the contents described above, due to the characteristic of the memory to which the memory managing device according to the embodiment of the present invention is applied, the power consumption setting unit can set the storage regions other than the second set of storage regions having active block in the memory described above to a low power consumption status, so as to reduce the whole power consumption of the memory.

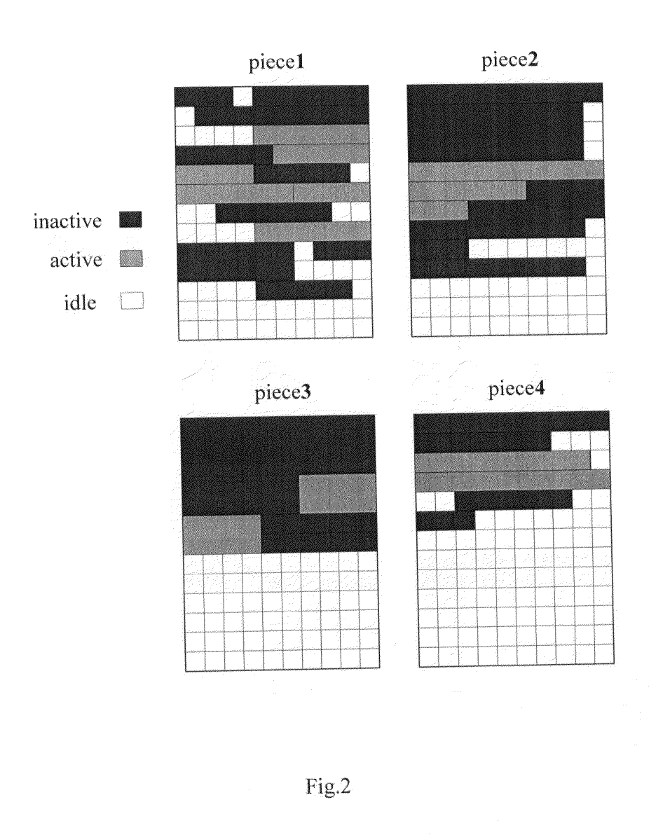

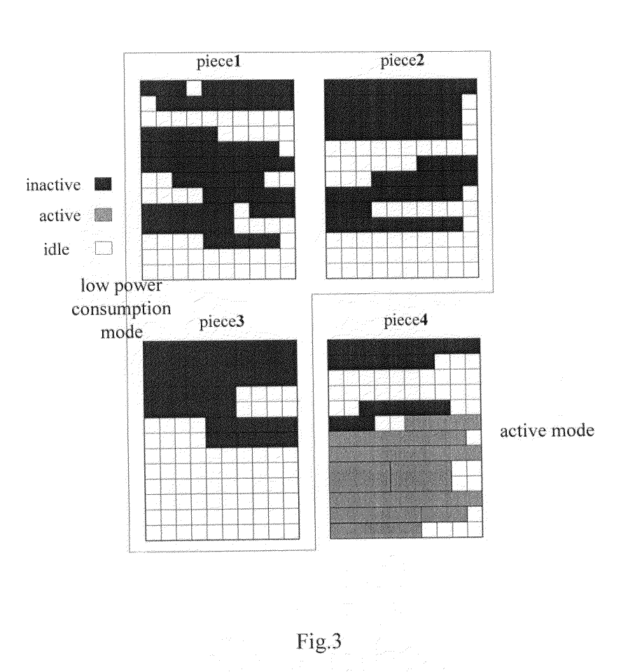

FIG. 2 is a schematic diagram illustrating the storage instance of the memory before the memory managing device according to the embodiment of the present invention carries out a segment arrangement; As illustrated in FIG. 2, it assumes that the memory is constituted by 4 storage regions, i.e., pieces 1 to 4 in FIG. 2, and at this time, there exists active blocks, inactive blocks and idle blocks in the four storage regions of pieces 1 to 4 in the memory. FIG. 3 is a schematic diagram illustrating the storage instance of the memory after the memory managing device according to the embodiment of the present invention carries out a segment arrangement. As illustrated in FIG. 3, after the segment arrangement, the active block in pieces 1 to 3 are moved into the piece 4, thus, since there is no active block in pieces 1 to 3 no longer, all of the pieces 1 to 3 are set to low power consumption mode, and only piece 4 is maintained as the active mode, thus, the whole systematic power consumption of the memory is reduced three-quarter so as to reduce power consumption significantly.

In the memory managing device according to the embodiment of the present invention, the low power consumption status described above may be a sleep mode or a power-off mode, i.e., the storage region without active block can be set as sleep mode, and, in case that each storage region is controlled by a separate power supply, the power supply of the storage region without active block can be turned off.

Further, in the memory managing device according to the embodiment of the present invention, for example, in the example shown in FIGS. 2 and 3, the segment is arranged in units of blocks, i.e., the minimum unit of the segment arrangement of the memory is a block of the memory. Here, for the current product based on NVRAM, the size of the block is not limited strictly, however, the number of the blocks on one NVRAM generally does not exceed 32. For example, for a NVRAM with size of 1G, the size of the block may be 32M. In the case described above, for the larger application or other data file, there may exist the case of being divided by the block size described above, that is, the application or other data file may occupy a plurality of blocks, and these blocks are not in active or inactive status simultaneous. For example, taking application program as example, the application program may comprise a plurality of modules, and at a certain specific runtime, some one or more modules of the application may not be activated yet and in sleep status, thus, the application may be divided into a plurality of parts and stored in different storage regions when the segment arrangement is carried out, which may cause the slowing of the entire running speed of the system.

Therefore, in the memory managing device according to the embodiment of the present invention, the segment arranging unit arranges the segment in units of a single data file, for example, this single data file may be an application program, thus, it ensures that a single integrated application program is stored in a same storage region so as to avoid the problem of slowing of the running speed of the system caused by read-write across storage regions.

Further, since in the procedure of the practical usage, different data files, for example video files and audio files may be used associated with each other, the read and write operation of the system will be facilitated if they are stored in a same storage region. And, different applications may be used associated with each other, for example, the user may listen to music while browsing the web-page, and at this time, the read and write operation of the system would be facilitated if the browser application program and the music player application program are stored in a same storage region. However, if the data file to be stored, for example the application program, can't be stored in a same storage region due to the size being too large, they are preferably stored in adjacent storage regions to facilitate the read and write operation of this data file. Therefore, the segment arranging unit can further comprise a data associating module configured to associate a specific plurality of data files, and the segment arranging unit is configured to move the plurality of data files associated by the data associating module to the same storage region or adjacent storage regions in the memory.

As is mentioned above, the plurality of data files associated with each other may be associated automatically by the data associating module based on attribute of the data files, for example, the video and audio file belonging to the same program, and they may be associated based on the preference of user, for example, the browser application program and the music player application program are associated with each other based on the preference of user.

Further, in addition to associating automatically a plurality of data files based on the attribute of the data files, In the memory managing device according to the embodiment of the present invention, the association between the data files can be set based on the history record, that is, the data associating unit can create a history record table of the active data file for recording the active data file each time when the storage detecting unit detects the storage status of the memory, so that the data associating module associate a plurality of data files being active simultaneously in a plurality of detections performed at several times.

Therefore, the memory managing device according to the embodiment of the present invention increases the usage rate of the memory and reduces the power consumption thereof by arranging all of the active blocks into less physical storage regions.

In the memory managing device according to the embodiment of the present invention, the user can set the time granularity of the detection. Further, a default value can be preset so that the memory managing device carries out the detection and arrangement of the segment according to the default value. In practice, the apparatus generally generates a certain amount of segment in about 30 days, thus, the procedure of the detection and arrangement of the segment can be set as being carried out automatically every 30 days. Further, since the segment arranging unit of the memory managing device according to the embodiment of the present invention should run when the computer is idle, it can set the condition that the usage rate of the CPU is less than 1% for 10 minutes as a trigger of the detection and arrangement of the segment.

According to another aspect of the embodiment of the present invention, there provides a memory managing method applied to a memory having a plurality of storage regions capable of being separated physically, comprising: detecting the current storage status of the memory; computing the current active block in the memory based on the current storage status of the memory; deciding whether the discreteness of a segment in the memory is larger than a predetermined threshold based on a storage address of the current active block; arranging the segment when the discreteness is larger than the predetermined threshold to move the active block to a second set of storage regions in the memory, wherein, the active block is in a first set of storage regions before being moved, and the number of the storage region in the first set of storage regions is larger than the number of the storage region in the second set of storage regions; and setting the storage regions other than the second set of the storage regions in the memory to a low power consumption status.

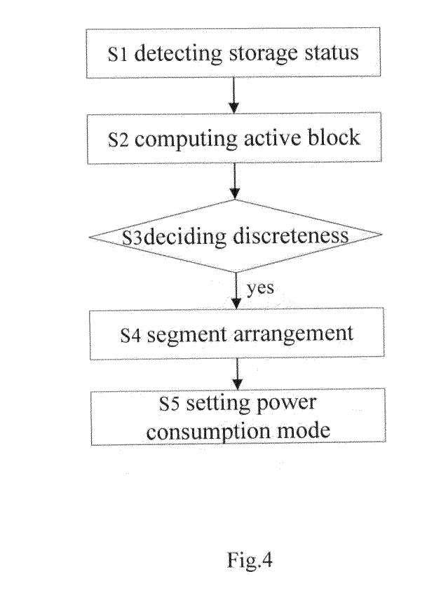

FIG. 4 is a schematic flow chart illustrating the memory managing method according to the embodiment of the present invention. As illustrated in FIG. 4, the memory managing method according to the embodiment of the present invention is applied to a memory having a plurality of storage regions capable of being separated physically, and comprises: S1, detecting the current storage status of the memory; S2, computing the current active block in the memory based on the current storage status of the memory; S3, deciding whether the discreteness of a segment in the memory is larger than a predetermined threshold based on a storage address of the current active block; S4, arranging the segment when the discreteness is larger than the predetermined threshold to move the active block to a second set of storage regions in the memory, wherein, the active block is in a first set of storage regions before being moved, and the number of the storage region in the first set of storage regions is larger than the number of the storage region in the second set of storage regions; and S5, setting the storage regions other than the second set of the storage regions in the memory to a low power consumption status.

In the memory managing method, the memory is a NVRAM memory.

In the memory managing method, the low power consumption status is a sleep mode or a power-off mode.

In the memory managing method, arranging the segment is specifically arranging the segments in units of a single data file.

In the memory managing method, arranging the segment further comprises: associating a specific plurality of data files; and moving the plurality of data files associated to the same storage region or adjacent storage region in the memory.

In the memory managing method, associating a specific plurality of data files specifically comprises: associating the plurality of data files based on the attribute of the data files or the preference of user.

In the memory managing method, associating a specific plurality of data files specifically comprises: creating a history record table of the active data file for recording the active data file each time when the storage status of the memory is detected, and associating a plurality of data files being active simultaneously in a plurality of detections performed at several times.

Here, the other details of the memory managing method according to the embodiment of the present invention are the same as those of the memory managing apparatus according to the embodiment of the present invention, and they will not be described for avoiding redundancy.

According to another aspect of the embodiment of the present invention, there provides an electronic apparatus comprising a memory having a plurality of storage regions capable of being separated physically, further comprising: a storage detecting unit for detecting the current storage status of the memory; a block computing unit for computing the current active block in the memory based on the current storage status of the memory; a discreteness deciding unit for deciding whether the discreteness of a segment in the memory is larger than a predetermined threshold based on a storage address of the current active block; a segment arranging unit for arranging the segment when the discreteness is larger than the predetermined threshold to move the active block to a second set of storage regions, wherein, the active block is in a first set of storage regions before being moved, and the number of the storage region in the first set of storage regions is larger than the number of the storage region in the second set of storage regions; and a power consumption setting unit for setting the storage regions other than the second set of the storage regions in the memory to a low power consumption status.

As is mentioned above, the electronic apparatus according to the embodiment of the present invention can be a conventional computer, and it can be other electronic apparatus such as smart phone, or home appliance having memory, the embodiment of the present invention does not intend to make any restriction thereto.

With the memory managing device and method and electronic apparatus according to the embodiment of this application, all of the active blocks in the memory can be concentrated to less physical storage regions so that the power consumption of the memory can be reduced while the efficiency of the usage of the memory can be increased.

Those skilled in the art can understand that, the units and algorithm steps of the examples described in combination with the embodiments disclosed in the specification can be implemented by an electronic hardware, a computer software or both of them, in order to explain the interchangeability of hardware and software clearly, the constitution and step of the respective examples is described generally according to the functions in the above explanation. Whether these functions are implemented by hardware or software depends on the specific application of the technical solution and the design restrictions. Those skilled in the art can use different methods to implement the described function for each specific application, and this implementation should not be regarded as beyond the disclosure of the invention.

Those skilled in the art can understand the detailed operational procedure of the system, apparatus and method mentioned above and can correspond to the corresponding procedure in the method embodiment, for the convenience and simplicity of description, the detailed operational procedure shall not be described any more.

In the several embodiments in the invention, it can be understood that the disclosed system, apparatus and method can be implemented by other means. For example, the apparatus embodiment mentioned above is only schematic, for example, the division of the units is only a logical functional division, and there can be other means of division for practical use, for example, multiple units or components can be combined or integrated to another system, or some features can be omitted, or do not operate. Further, the coupling therebetween or the direct coupling or communication connection can be implemented by indirect coupling or communication connection of some interfaces, apparatus and units, and they can be electric, mechanic or in other form.

The units described as separate components may be or may not be physically separated, the components shown as units may be or may not be physical units, i.e., they can be located at a same position, or distributed on a plurality of network units. The object of the solution of the embodiment can be implemented by selecting part or all of the units according to the practical need.

Further, the respective functional units in the respective embodiments of the invention can be integrated in a processing unit, and the respective units can be individual, or two or more of units can be integrated in a unit. The above integrated unit can be implemented in the form of hardware or in the form of software functional unit.

If the integrated unit is implemented in the form of software functional unit and sold and used as an individual product, it can be stored in a computer readable storage medium. Based on this understanding, the essential technical solution of the invention or the part contributed to the related art or part or all of the technical solution can be embodied as a software product, and this computer software product is stored on storage medium, includes some instructions to cause a computer (PC, server or networked apparatus, etc.) to perform part or all of the steps of the method of the embodiment of the invention. And the storage medium includes medium storing program code such as U disc, mobile hard driver, ROM, RAM, magnetic disc or optical disc, etc.

The contents described above are only the preferred implementation for carrying out the invention. It should be pointed out that, for those ordinarily skilled in the art, on the condition of not deviating from the principle mentioned in the present invention, several improvements and refinements can be made as well, which should be also treated as the scope protected by the present invention.

1. A memory managing device applied to a memory having a plurality of storage regions capable of being separated physically, comprising:
a storage detecting unit configured to detect the current storage status of the memory;
a block computing unit configured to compute the current active block in the memory based on the current storage status of the memory;
a discreteness deciding unit configured to decide whether the discreteness of a segment in the memory is larger than a predetermined threshold based on a storage address of the current active block;
a segment arranging unit configured to arrange the segment when the discreteness is larger than the predetermined threshold to move the active block to a second set of storage regions, wherein, the active block is in a first set of storage regions before being moved, and the number of the storage region in the first set of storage regions is larger than the number of the storage region in the second set of storage regions; and
a power consumption setting unit configured to set the storage regions other than the second set of storage regions in the memory to a low power consumption status.

2. The memory managing device according to claim 1, wherein, the memory is a NVRAM memory.

3. The memory managing device according to claim 1, wherein, the low power consumption status is a sleep mode or a power-off mode.

4. The memory managing device according to claim 1, wherein, the segment arranging unit is configured to arrange the segment in units of a single data file.

5. The memory managing device according to claim 1, wherein, the segment arranging unit further comprises:
a data associating module configured to associate a specific plurality of data files, wherein,
the segment arranging unit is configured to move the plurality of data files associated by the data associating module to same storage region or adjacent storage regions in the memory.

6. The memory managing device according to claim 5, wherein, the data associating module is configured to associate the plurality of data files based on the attribute of the data files or the preference of user.

7. The memory managing device according to claim 5, wherein, the data associating unit is configured to create a history record table of the active data file for recording the active data file each time when the storage detecting unit detects the storage status of the memory, and
the data associating module is configured to associate a plurality of data files being active simultaneously in a plurality of detections performed at several times.

8. A memory managing method applied to a memory having a plurality of storage regions capable of being separated physically, comprising:
detecting the current storage status of the memory;
computing the current active block in the memory based on the current storage status of the memory;
deciding whether the discreteness of a segment in the memory is larger than a predetermined threshold based on a storage address of the current active block;
arranging the segment when the discreteness is larger than the predetermined threshold to move the active block to a second set of storage regions in the memory, wherein, the active block is in a first set of storage regions before being moved, and the number of the storage region in the first set of storage regions is larger than the number of the storage region in the second set of storage regions; and
setting the storage regions other than the second set of the storage regions in the memory to a low power consumption status

9. The memory managing method according to claim 8, wherein, the memory is a NVRAM memory.

10. The memory managing method according to claim 8, wherein, the low power consumption status is a sleep mode or a power-off mode.

11. The memory managing method according to claim 8, wherein, arranging the segment is specifically arranging the segment in units of a single data file.

12. The memory managing method according to claim 8, wherein, arranging the segment further comprises:
associating a specific plurality of data files; and
moving the plurality of data files associated to same storage region or adjacent storage regions in the memory.

13. The memory managing method according to claim 12, wherein, associating a specific plurality of data files specifically comprises:
associating the plurality of data files based on the attribute of the data files or the preference of user.

14. The memory managing method according to claim 12, wherein, associating a specific plurality of data files specifically comprises:
creating a history record table of the active data file for recording the active data file each time when the storage status of the memory is detected, and
associating a plurality of data files being active simultaneously in a plurality of detections performed at several times.

15. An electronic apparatus comprising a memory having a plurality of storage regions capable of being separated physically, further comprising:
a storage detecting unit for detecting the current storage status of the memory;
a block computing unit for computing the current active block in the memory based on the current storage status of the memory;
a discreteness deciding unit for deciding whether the discreteness of a segment in the memory is larger than a predetermined threshold based on a storage address of the current active block;
a segment arranging unit for arranging the segment when the discreteness is larger than the predetermined threshold to move the active block to a second set of storage regions, wherein, the active block is in a first set of storage regions before being moved, and the number of the storage region in the first set of storage regions is larger than the number of the storage region in the second set of storage regions; and
a power consumption setting unit for setting the storage regions other than the second set of the storage regions in the memory to a low power consumption status.
